(19) United States
(12) Patent Application Publication
(10) Pub. No.: US 2011/0246366 A1
(43) Pub. Date: Oct. 6, 2011

(54) AUTHENTICATION USING TELECOMMUNICATIONS DEVICE

(76) Inventor: Pin Yong Lai, Selangor (MY)

(21) Appl. No.: 13/131,880

(22) PCT Filed: Dec. 11, 2009
(86) PCT No.: PCT/MY2009/000205

§ 371 Date: May 31, 2011

(30) Foreign Application Priority Data
Dec. 18, 2008 (MY) PI 20085132

(51) Int. Cl. G06Q 40/00

(52) U.S. Cl. 705/44

(57) ABSTRACT

A method for authenticating a transaction being conducted remotely of a commerce server is disclosed. The method comprises selecting a telephone number from a pool of telephone numbers and making a telephone call to a registered telecommunications device, the telephone call being made with caller identification activated. A prompt is provided for the entry of at least a part of the telephone number as an authentication of the transaction. Upon the telephone number being entered within a set time the transaction is approved and effected.

### TECHNICAL FIELD

This invention relates to authentication using a telecommunications device and refers particularly, though not exclusively, to a method of authentication of a proposed transaction by use of a mobile telecommunications device.

### DEFINITIONS

Throughout this specification a reference to a telecommunications device is to be taken as including any device capable of making telephone calls over a telephone network including, but not restricted to, a mobile/cellular telephone network; and includes a telephone, mobile telephone, cellular telephone, telephone-enabled PDA, telecommunications-enabled devices such as a “Blackberry”, and telephone-enabled computers such as notebooks, laptops, tablets, and so forth.

### BACKGROUND

There have been many proposals for the use of a telephone to authenticate a transaction being conducted remotely. That may include a transaction at an ATM, an on-line transaction using a computer, or a transaction using a web-enabled mobile telecommunications device. These have mainly relied upon the use of an SMS to send an authentication code to the registered mobile telecommunications device. However, there are normally time limits associated with the entry of the authentication code. At peak operating periods it can take many minutes for the SMS to arrive. Quite often this will be after the time-lockout for the authentication of the transaction has taken place thereby terminating the transaction.

Others have used telephone calls to the registered telephone number. These may be time consuming, inconvenient and may involve operators asking questions of the user. Variants may involve an authentication code being given to the user by means of a telephone call. The user then has to either remember the authentication code, or write it down. It can then be entered using the ATM, computer or the like. The user may not have access to a pen and paper or may forget the authentication code. Either way, the system is unreliable and fraught with danger. A simpler and more reliable system is required.

### SUMMARY

According to an exemplary aspect there is provided a method for authenticating a transaction being conducted remotely of a commerce server. The method comprises selecting a telephone number from a pool of telephone numbers and making a telephone call to a registered telecommunications device, the telephone call being made with caller identification activated. A prompt is provided for the entry of at least a part of the telephone number as an authentication of the transaction. Upon the telephone number being entered within a set time the transaction is approved and effected.

The telephone call may be continued until an indication is received that the telecommunications device has received the telephone call. The pool of telephone numbers may be maintained by one of: the commerce server, and an authentication server. The selecting of the telephone number may be by the commerce server. The commerce server may send the telephone number to the authentication server with instructions to obtain authentication of the transaction. Alternatively, the selecting of the telephone number may be by the authentication server. The authentication server may obtain the telephone number after receiving from the commerce server instructions to obtain authentication of the transaction.

The transaction may be required to be authenticated only if it is a defined transaction. The telephone number may be selected from the pool of telephone numbers by one of: random, and selection.

After the indication is received, the telephone call may be stopped. The indication may be a detecting of a ringing of the telecommunications device. The telephone call may be stopped after a prescribed number of rings and/or a prescribed time after the telephone call is made. The indication may be received by the authentication server.

The prompt may be provided by the commerce server. The prompt may be sent after the indication is received. The prompt may be sent to, and the telephone number may be entered using, a telecommunications-enabled computation device selected from: a computer, an automated teller machine, point-of-sale terminal, and a telecommunications-enabled computation device.

The authentication server may communicate to the commerce server at least one of: the number of the telephone call, commencement of the telephone call, a success of the telephone call, a failure of the telephone call, and when the telephone call is stopped. The telephone number may be required to be entered in full or in part. The telephone call may be made using the telephone number.

The authentication server may determine a caller identification number that may be sent to the telecommunications device. The authentication server may generate an arbitrary or pseudo telephone number to be used as a caller identification number and may insert the arbitrary or pseudo telephone number in a call setup message sent by the authentication server to a telecommunications service provider when making the telephone call.

The commerce server may be: a banking server, an e-commerce web server, a web server with a login page, and a web server for a subscription web site.

The transaction may be refused when there takes place at least one of: the at least a part of the telephone number is not correctly entered, the at least a part of the telephone number is not entered within the set time, the indication is not received, the indication is not received within a prescribed time, and the telephone call fails.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a schematic illustration of an exemplary embodiment of the system architecture; and

FIG. 2 is a flow chart of the operation of the exemplary embodiment of FIG. 1.

### DETAILED DESCRIPTION OF THE EXEMPLARY EMBODIMENTS

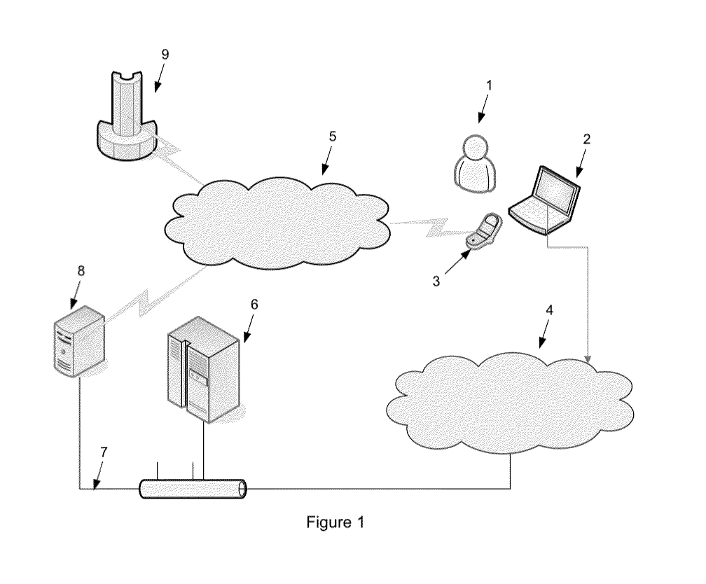

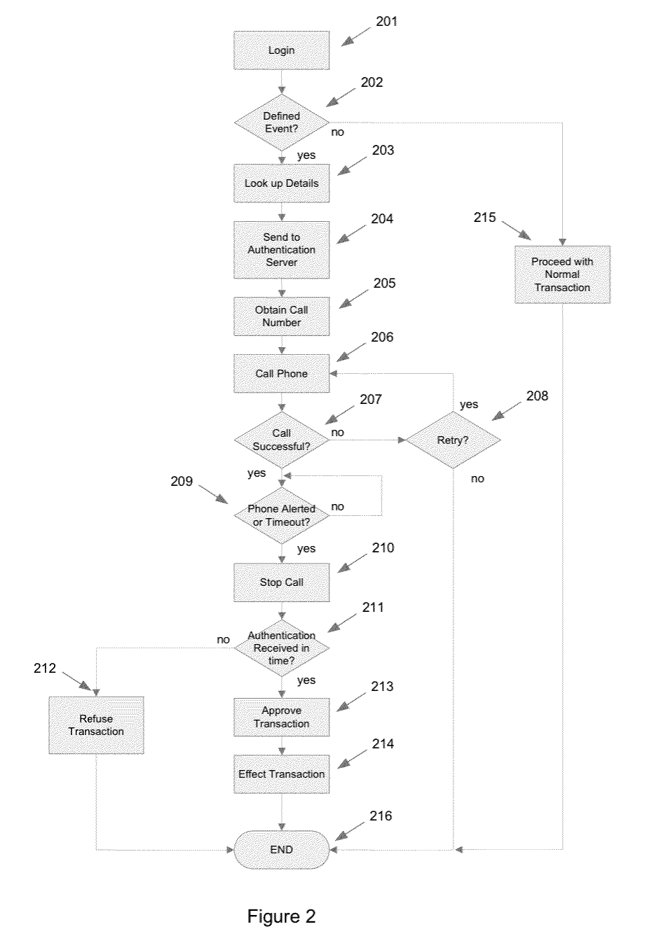

As shown in FIGS. 1 and 2, there is a user 1 who has a computer 2 and a telecommunications device 3. The computer 2 may be a computer (as shown), ATM, POS terminal, or any other telecommunications-enabled computation device. The computer 2 is used to access an account by using the Internet 4 to gain access to an on-line commerce server 6. The commerce server 6 may be a banking server, e-commerce web server, a web server with a login page, a web server for a subscription web site, and so forth. The commerce server 6 is functionally linked to an authentication server 8 by a communications channel 7. The authentication server 8 is able to make telephone calls over a public switched telephone network 5 operated by a telecommunications service provider 9. The telecommunications service provider 9 provides to the authentication server 8 a large pool of telephone numbers the authentication server 8 may use for authenticating transactions. The telecommunications device 3 is also operatively connected or connectable to the network 5.

When the user 1 registers with the commerce system of the server 6, the user 1 provides the telephone number of his telecommunications device 3. This number may be updated, amended or changed when and as required, and in any suitable manner.

When the computer 2 logs in to the commerce server 6 (201) and requests a transaction, the commerce server 6 determines if the transaction is a defined event (202). A defined event is an event requiring authentication beyond the account name/password combination normally required. A transaction may be a defined event due to many factors including, but not limited to: the value of the transaction, the timing of the transaction, a balance of the account, the inherent nature of the transaction, and so forth. If it is not a defined event, the following procedure is ignored, and the transaction proceeds normally (215).

Alternatively, a transaction or a defined event may be all events that encompass all subsequent interactions with user 1.

If the transaction is a defined event, the commerce server 6 looks up the required information for authentication including details of the account to obtain information of the telecommunications device 3, and in particular the telephone number of the telecommunications device 3 (203). Upon obtaining the required information the commerce server 6 instructs the authentication server 8 to request authentication and provides to the authentication server 8 the telephone number of the telecommunications device 3 (204).

Alternatively, the required information may be stored by the authentication server 8 and the authentication server 8 can look up the required information on receipt of the instruction from the commerce server 6.

When the authentication server 8 has received the instruction and has obtained the required information, it obtains a telephone number from the pool of telephone numbers (205). This may be at random, or may be by selection. Selection may be based on a number of criteria including, but not limited to: numbers previously used to call the telecommunications device 3, the location of the telecommunications device 3, the nature of the transaction, the value of the transaction, the account status, and so forth.

As a further alternative, the pool of telephone numbers may be stored at the commerce server 6 and the commerce server 6 may obtain the telephone number to be used in accordance with the above description. The commerce server 6 may then send the telephone number to the authentication server 8 at the same time as it sends to instruction.

The authentication server 8 then makes a telephone call to the telecommunications device 3 over the PSTN 5 (206) using the telephone number obtained in step (205). This may be done by the authentication server 8 specifying the telephone number in a call setup message sent to the telecommunications service provider 9 when making the telephone call. As caller identification is the domain of the call maker not the recipient, and by having caller identification activated by the authentication server 8, upon the telecommunications device 3 receiving the call the display of the telecommunications device 3 will show the telephone number used by the authentication server 8. The authentication server 8 checks if the call is made successfully (207) and it may retry a predetermined number of times if it is not successful (208). When the authentication server 8 detects that the telephone call has been received by the telecommunications device 3 and that the number has also been transmitted (209), the authentication server 8 stops the call (210). This may be before the telecommunications device 3 has answered the telephone call, thereby avoiding call charges. Detection may be by determining that the telecommunications device 3 is “ringing”. The stopping of the telephone call (210) may be after a prescribed number of “rings” of the telecommunications device 3 or after a predetermined time such as, for example, ten seconds. If the telecommunications device 3 answers the telephone call before the call is stopped, a pre-recorded message may be played by the authentication server 8 and the call is then stopped. After the telephone call has been made, the telephone call may be stopped after the predetermined time or timeout (209) even though the indication has not been received.

Upon the telephone call being received by the telecommunications device 3 (209), the commerce server 6 provides a prompt to the computer 2 for the telephone number of the pool of telephone numbers that was used for the telephone call to be entered at the computer 2 as authentication for the transaction. Alternatively, the prompt may be sent independent of when the telephone call is made by the authentication server 8. Preferably, the computer 2 may also provide this prompt independently. It is preferred for the number to be entered within a set time of the start of the making of the telephone call, or from the providing of the prompt (211). If the telephone number is not entered by the computer 2 within the set time, the transaction may be refused or denied (212) and the process ends (216). The prompt is provided after the telephone call is made but may be before or after the telephone call is stopped (210). All or a part of the telephone number may be required to be entered such as, for example, the last six digits.

The authentication server 8 also communicates to the commerce server 6 the number of the telephone call, the commencement of the telephone call, the success or failure of the telephone call, and when the telephone call is stopped so that the commerce server 6 will know when to send the prompt, and when the time limit for entry of the telephone number will expire.

If the telephone number is received by the commerce server 6 in time, and is accurate, the commerce server 6 can approve the transaction (213) and effect the transaction (214). The process then ends (216).

The method may be used when the computer 2 is a personal computer, an automated teller machine (ATM), a point-of-sales (POS) terminal or any telecommunications-enabled computation device. Alternatively, 4 may be a dedicated data link such as a leased line through which the computer 2 communicates with the commerce server 6. The commerce server 6 and the authentication server 8 may be separate (as shown) or may be integral. The commerce server 6 may be any server running programs having the necessary business logic. For examples, the commerce server 6 may be a banking server, an e-commerce web server, a web server with a login page, and a web server for a subscription web site. Alternatively, the authentication method described above can be used standalone or independent of any other forms of authentication methods.

In addition to or as an alternative to the pool of telephone numbers, the authentication server 8 may determine the caller identification number to be sent to and displayed on the telecommunications device 3 (205). This may be by the authentication server 8 generating arbitrary or pseudo telephone numbers to be used as caller identification numbers and inserting those numbers in the call setup messages sent by the authentication server 8 to the telecommunications service provider 9 when making calls.

From the description above, it can be seen that for a successful authentication to be made at the commerce server 6, the user 1 must have the telecommunications device 3 which is registered with the commerce server 6 or the authentication server 8. The telephone call made from the authentication server 8 to the registered telecommunications device 3 is done using a telephone number unknown to user 1 in advance. Hence, without the registered telecommunications device 3, user 1 would not be able to enter the correct telephone number when prompted by the commerce server 8 or the computer 2. Preferably, the account of user 1 may be barred after a predetermined number of wrong authentication attempts.

Whilst the foregoing description has described exemplary embodiments, it will be understood by those skilled in the technology concerned that many variations in details of design, construction and/or operation may be made without departing from the present invention.

1. A method for authenticating a transaction being conducted remotely of a commerce server, the method comprising:
selecting a telephone number from a pool of telephone numbers;
making a telephone call to a registered telecommunications device, the telephone call being made with caller identification activated;
providing a prompt for the entry of at least a part of the telephone number as an authentication of the transaction; and
upon the telephone number being entered within a set time the transaction is approved and effected.

2. A method as claimed in claim 1, wherein the telephone call is continued until an indication is received that the telecommunications device has received the telephone call.

3. A method as claimed in claim 1 or claim 2, wherein the pool of telephone numbers is maintained by one of: the commerce server, and an authentication server.

4. A method as claimed in claim 3, wherein the selecting of the telephone number is by the commerce server, the commerce server sending the telephone number to the authentication server with instructions to obtain authentication of the transaction.

5. A method as claimed in claim 3, wherein the selecting of the telephone number is by the authentication server, the authentication server obtaining the telephone number after receiving from the commerce server instructions to obtain authentication of the transaction.

6. A method as claimed in any one of claims 1 to 2, wherein the transaction is required to be authenticated only if it is a defined transaction.

7. A method as claimed in any one of claims 3 to 5, wherein the transaction is required to be authenticated only if it is a defined transaction.

8. A method as claimed in any one of claims 1 to 2, wherein the telephone number is selected from the pool of telephone numbers by one of: random, and selection.

9. A method as claimed in any one of claims 3 to 7, wherein the telephone number is selected from the pool of telephone numbers by one of: random, and selection.

10. A method as claimed in claim 2, wherein after the indication is received, the telephone call is stopped.

11. A method as claimed in any one of claims 3 to 9, wherein after the indication is received, the telephone call is stopped.

12. A method as claimed in claim 8, wherein the indication is a detecting of a ringing of the telecommunications device.

13. A method as claimed in claim 11, wherein the indication is a detecting of a ringing of the telecommunications device.

14. A method as claimed in claim 12, wherein the telephone call is stopped after a prescribed number of rings.

15. A method as claimed in claim 13, wherein the telephone call is stopped after a prescribed number of rings.

16. A method as claimed in any one of claims 1 to 2, wherein the telephone call is stopped a prescribed time after the telephone call is made.

17. A method as claimed in any one of claims 3 to 13, wherein the telephone call is stopped a prescribed time after the telephone call is made.

18. A method as claimed in any one of claims 3 to 17, wherein the indication is received by the authentication server.

19. A method as claimed in any one of claims 1 to 2, wherein the prompt is provided by the commerce server.

20. A method as claimed in any one of claims 3 to 18, wherein the prompt is provided by the commerce server.

21. A method as claimed in claim 2, wherein the prompt is sent after the indication is received.

22. A method as claimed in any one of claims 3 to 20, wherein the prompt is sent after the indication is received.

23. A method as claimed in any one of claims 1 to 2, wherein the prompt is sent to, and the telephone number is entered using, a telecommunications-enabled computation device selected from the group consisting of: a computer, an automated teller machine, point-of-sale terminal, and a telecommunications-enabled computation device.

24. A method as claimed in any one of claims 3 to 22, wherein the prompt is sent to, and the telephone number is entered using, a telecommunications-enabled computation device selected from the group consisting of: a computer, an automated teller machine, point-of-sale terminal, and a telecommunications-enabled computation device.

25. A method as claimed in any one of claims 3 to 24, wherein the authentication server communicates to the commerce server at least one selected from the group consisting of: the number of the telephone call, a commencement of the telephone call, a success of the telephone call, a failure of the telephone call, and when the telephone call is stopped.

26. A method as claimed in any one of claims 1 to 2, wherein the telephone number is required to be entered in full or in part.

27. A method as claimed in any one of claims 3 to 25, wherein the telephone number is required to be entered in full or in part.

28. A method as claimed in any one of claims 1 to 2, wherein the telephone call is made using the telephone number.

29. A method as claimed in any one of claims 3 to 27, wherein the telephone call is made using the telephone number.

30. A method as claimed in any one of claims 3 to 29, wherein the authentication server determines a caller identification number that is sent to the telecommunications device.

31. A method as claimed in claim 30, wherein the authentication server generates an arbitrary or pseudo telephone number to be used as a caller identification number and inserts the arbitrary or pseudo telephone number in a call setup message sent by the authentication server to a telecommunications service provider when making the telephone call.

32. A method as claimed in any one of claims 1 to 2, wherein the commerce server is selected from the group consisting of: a banking server, an e-commerce web server, a web server with a login page, and a web server for a subscription web site.

33. A method as claimed in any one of claims 3 to 31, wherein the commerce server is selected from the group consisting of: a banking server, an e-commerce web server, a web server with a login page, and a web server for a subscription web site.

34. A method as claimed in any one of claims 1 to 2, wherein the transaction is refused when there takes place at least one selected from the group consisting of: the at least a part of the telephone number is not correctly entered, the at least a part of the telephone number is not entered within the set time, the indication is not received, the indication is not received within a prescribed time, and the telephone call fails.

35. A method as claimed in any one of claims 3 to 33, wherein the transaction is refused when there takes place at least one selected from the group consisting of: the at least a part of the telephone number is not correctly entered, the at least a part of the telephone number is not entered within the set time, the indication is not received, the indication is not received within a prescribed time, and the telephone call fails.
